(19) United States
(12) Patent Application Publication
(10) Pub. No.: US 2009/0155460 A1
(43) Pub. Date: Jun. 18, 2009

(54) METHOD AND SYSTEM FOR IMPROVING CONDUCTIVITY AND MECHANICAL PERFORMANCE OF CARBON NANOTUBE NETS AND RELATED MATERIALS

(76) Inventor: Rodney Ruoff, Austin, TX (US)

Correspondence Address: HULSEY IP INTELLECTUAL PROPERTY LAWYERS, P.C., 919 Congress Avenue, Suite 919, AUSTIN, TX, 78701, US

(21) Appl. No.: 12/233,436

(22) Filed: Sep. 18, 2008

Related U.S. Application Data
(60) Provisional application No. 60/973,249, filed on Sep. 18, 2007.

(51) Int. Cl. B05D 5/12

(52) U.S. Cl. 427/113; 977/748; 977/847; 977/750

(57) ABSTRACT

A method and system for improving conductivity and mechanical performance of carbon nanotube nets and related materials.

### CROSS REFERENCE TO RELATED APPLICATIONS

This application claims the benefit of priority to U.S. Provisional Patent Application No. 60/973,249 filed Sep. 18, 2007 by Rodney Ruoff entitled, “Method and System for Improving Conductivity and Mechanical performance of Carbon Nanotube Nets and Related Materials” and is incorporated herein by it entirety.

### FIELD

This disclosure relates in general to the field of thin films, and more particularly to thin films composed of carbon nanotubes (CNTs), and even more particularly to electrical and thermal conductivity and mechanical properties of thin films composed of CNTs.

### DESCRIPTION OF THE RELATED ART

Substantial literature exists, describing CNT nets and the electrical, thermal, or mechanical performance of CNT nets (also at times referred to as ‘bucky paper’, ‘carbon nanotube thin films’, ‘transparent conductive films composed of carbon nanotubes’ and so on).

The main reason that CNT nets do not have a significantly higher electrical conductivity is because the impedance at the nodes (where two different CNTs intersect) is significantly larger than the impedance of the segments of CNTs away from the nodes. In short, the electrical conductivity of the straight CNT segments is much larger than the electrical conductivity in the node regions. The same holds true for the thermal conductivity, which is strongly limited by the high thermal resistance at the nodes. In the same sense, the weak adhesion at the node means that the mechanical performance is typically controlled by sliding at the node regions, where typically the only “bonding” present is of the van der Waals type.

A need exists, therefore, for improving the transparent electrically conductive thin film performance beyond what has been achieved to date.

Transparent conductive films (TCFs) are of tremendous technological and economic importance in a broad array of existing and future applications, including in solar cells and image technology (flat panel, etc.), as well as in flexible electronics. However, currently used TCFs such as indium tin oxide (ITO) have drawbacks such as cost and mechanical limitations, among others.

A need exists, therefore, for potential replacement materials to address the drawbacks of currently used TCFs.

TCFs can be created from 1-D nanostructures such as CNTs. One example application is a networks of CNTs deposited by any of a number of methods (spray-coating, screen-printing, by filtering them from a dispersion of them in a solvent, etc.), with a goal of maximizing the electrical conductivity and minimizing the absorbance of light.

A further need exists for a network of CNTs which maximizes transmittance and electrical conductivity.

The dominant factor in the performance of TCFs is the electrical resistance at the node (the region where two CNTs cross each other, and are in close proximity to each other).

A need exists, therefore, for a TCF which is designed to account for this dominant performance factor.

### SUMMARY

A method and system for improving conductivity and mechanical performance of carbon nanotube (CNT) nets and related materials is disclosed.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURE and detailed description.

### BRIEF DESCRIPTIONS OF THE DRAWINGS

The features, nature, and advantages of the disclosed subject matter may become more apparent from the detailed description set forth below when taken in conjunction with the drawings in which like reference characters identify correspondingly throughout and wherein:

FIGS. 1 and 2 show two crossed single-walled carbon nanotubes.

### DETAILED DESCRIPTION OF THE SPECIFIC EMBODIMENTS

The following disclosure presents concepts for improving the electrical conductivity, thermal conductivity and mechanical properties of thin films composed of carbon nanotubes (CNTs). Carbon nanotube nets (CNT nets) are defined as a random network of CNTs, such as in thin film form. The disclosed subject matter focuses on CNT nets, but it is understood that the individual elements could be NWs or NTs of other material composition that carbon, so long as the individual elements are either good electrical conductors, or thermal conductors, or both; or that have good mechanical properties as individual elements. Further, the disclosed subject matters focuses primarily on electrical conductivity, but it is to be understood that the concepts presented also allow significant improvement in thermal conductivity and also of mechanical performance of the CNT networks, when appropriately implemented.

The disclosed subject matter significantly improves upon prior art CNT nets, by improving the transparent electrically conductive thin film performance by reducing the contact resistance (the node impedance) at the nodes in the CNT nets, improving thermal conductivity by lowering the thermal resistance at the nodes, and optimizing mechanical properties by replacing the weak van der Waals bonding with more robust chemical bonding.

Improving the mechanical properties of CNT nets provides additional benefits for their subsequent use in myriad applications, such as filtering and embedding in structural materials including as a component for enhancing the properties of composites, among others.

As noted above, the dominant factor in the performance of TCFs is the electrical resistance at the node (the region where two CNTs cross each other, and are in close proximity to each other). The disclosed subject matter provides methods of lowering the contact resistance at the nodes in the network.

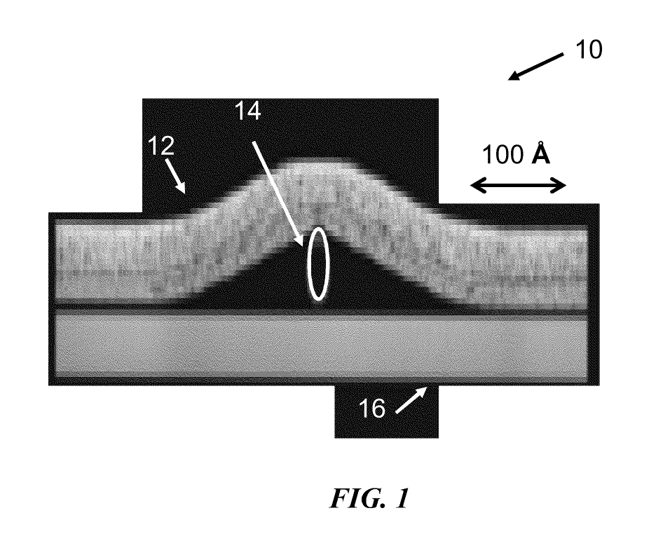

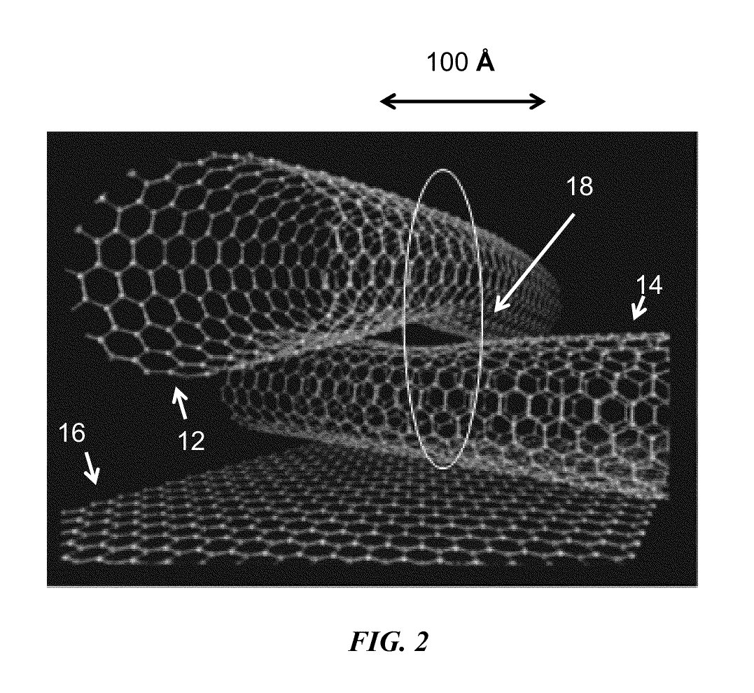

FIGS. 1 and 2 show views 10 and 20 of two crossed single-walled carbon nanotubes 12 and 14. For the purposes of the current disclosure, the underlying graphite surface 16 can be imagined not to be present. Node 18 (highlighted by the white oval) indicates schematically where deposition may occur.

The view 20 shown in FIG. 2 shows a perspective close-up of the crossing point. It shows that both tubes 12 and 14 are deformed elastically near the contact region 18. The force acting on the lower tube 14 is about 5 nN.

The general concept is to achieve deposition of a small amount of material at the nodes that lowers the node resistance. Without such a deposit, the contact resistance is largely controlled by two CNTs that are weakly linked at the nodes through the weak van der Waals forces, or possibly via an undesired contaminant residue from the processing used to make the CNTs or in fabricating the CNT net.

For CNT nets with high optical transmittance and low optical reflectance across a broad wavelength range, it would be most desirable to deposit material primarily or only at the node and not elsewhere. For example, consider single-walled carbon nanotubes (SWCNTs) that form the network. The transmittance is lowered if a shell of material uniformly coats all regions of the SWCNT network, provided the material being deposited is not itself non-absorbing for the spectral region of interest. Many electrically conductive materials are not transparent in some part of the spectrum; therefore, a part of the disclosed subject matter is directed to methods to deposit material primarily or only at the nodes, lowering the contact resistance dramatically. By lowering the contact resistance of the nodes, the overall (electrical or thermal or both) resistance of the network will be lowered, so that better TCFs can be made. Also, materials may be chosen that optimize the mechanical properties of the nodes so that the mechanical properties of TCFs based on such CNT networks are also optimized.

The following section outlines alternative methods for improving contact resistance at the nodes, as examples of a class of methods that will find use in the future to lower the contact resistance.

In one embodiment, a small amount of electrically conductive material is deposited.

A method for depositing such electrically conductive material includes exploiting drying of a solution or a colloidal or other liquid dispersion, so that deposition happens only or primarily at the nodes, due to drying effects (capillary forces). That is, as drying is occurring, the liquid (the solvent) is “drawn” into the node regions, and in the final stages of drying the solute (or colloidal particle if from a colloidal suspension, i.e., a liquid dispersion) is deposited in the node regions, selectively, or quasi-selectively. If needed, post-processing (steps such as any of heating to cure the deposit, exposure to light to cure the deposit, exposure to chemical reactants such as from a gas or liquid to convert the deposit to a more appropriate type of deposit with lower electrical resistance, and so on) may be used to yield the lowest electrical resistance deposit also having other favorable attributes such as durability.

An alternative method for depositing such electrically conductive material includes electrodeposition either by electroplating or electroless deposition. Optionally, a voltage bias may be applied. The electric field in the vicinity of the node is likely to be substantially higher (a voltage drop across a small separation) than in the segments, allowing for preferential deposition in the node regions.

Another alternative method for depositing such electrically conductive material includes transient heating of the network through short-time pulses of electrical current. Higher node resistance will result in preferential heating of the nodes compared to the segments, resulting in a temperature (T) difference between nodes and segments. This temperature difference allows for preferential deposition at the nodes. In one embodiment, this deposition results from gaseous reactants that the net is immersed in. An alternative heating method includes microwave heating, which has been shown to be an effective method for heating CNT nets. Pulses of microwave power may be applied in the presence of a gas which will react primarily in the higher temperature zones; if there is a small liquid drop at each of the nodes but not on the segments, then, microwave heating and thus temperature rise can be accelerated in the node regions, driving the desired deposition.

Another alternative method for depositing such electrically conductive material includes deposition of carbon (C) atoms (among others), which are likely to surface diffuse along the saturated covalently bonded CNTs, and thus to aggregate at the nodes. There are many other examples of materials that are not particularly effective at wetting the segment section of CNTs, among them gold and others, which are likely to build up in the node regions due to the potential well that favors binding at the nodes versus the segments.

Another alternative method for depositing such electrically conductive material includes deposition via chemical reactions which preferentially take place at the nodes, due to the close proximity of the CNTs. Reactants with the appropriate geometry and energetic considerations cross-link the crossed CNTs at the nodes, or wrap around the nodes, or are deposited preferentially at the nodes. For example, the deposition of appropriately sized (thus, relatively small lateral dimension) graphene-based sheets from liquid suspensions so that the sheets deposit primarily onto the nodes and also conform well by wrapping onto/around the nodes, is likely to enhance conductivity through a greater surface area of contact between the crossed CNTs and the overlying graphene-based sheets.

In the embodiments outlined above, a small amount of electrically conductive material is deposited. In an alternative method, a small amount of thermally conductive material is deposited. In the embodiments outlined above, if the material deposited is also a good thermal conductor or acts to lower the thermal resistance, then this will enhance the thermal conductivity of the CNT net. However, it should be noted that the material need not be electrically conductive. For example, boron nitride nanotubes have exceptional thermal conductivity; because of their large electrical band gap, these nanotubes are going to be, as a random network, highly transmitting for visible light. This serves as an example of a thermally conductive NT net capable of substantial further improvements by reducing thermal resistance at the nodes. Some good thermal conductors are also good electrical conductors, so the possibilities exist for improving the thermal and electrical conductivity, or the thermal or electrical conductivity, by deposition of the appropriate type of material.

Another alternative method for improving contact resistance at the nodes involves deposition of a small amount of material to enhance mechanical performance. By removing the constraint of having a sparse (highly porous) net of NTs or NWs in order to achieve good transparency for optical wavelengths, some coating of the segments, in addition to improving the mechanical connection at the nodes, may be allowed.

The above are given as representative of examples of what are likely to be many methods of depositing at the nodes so as to improve dramatically the electrical, thermal, or mechanical performance (or both, or all three) of such CNT nets and similar types of networks comprised of quasi-1D nanowires or nanotubes. By judicious use of appropriate chemical reactants and processing conditions (temperature, other reactants, flow, light, time, etc.), the node impedance can be lowered significantly compared to the prior art.

Another method of achieving selective deposition at the nodes is through electrophoresis/dielectrophoresis, where the electric field gradient is sharply varied in the node region, and is used to deposit, e.g., nanoparticles selectively at the nodes.

The foregoing description of the preferred embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A method for improving the electrical, thermal and/or mechanical properties of a carbon nanotube (CNT) network comprising the steps of:
starting with a CNT network; and,
preferentially depositing a material at the nodes of said CNT network.
